(19) United States
(12) Patent Application Publication
(10) Pub. No.: US 2015/0371577 A1
(43) Pub. Date: Dec. 24, 2015

(54) LIQUID CRYSTAL DISPLAY DEVICE, ELECTRONIC DEVICE, AND DRIVING METHOD FOR LIQUID CRYSTAL DISPLAY DEVICE

(71) Applicant: SEIKO EPSON CORPORATION, Tokyo (JP)

(72) Inventor: Hiroyuki HOSAKA, Matsumoto (JP)

(21) Appl. No.: 14/743,922

(22) Filed: Jun. 18, 2015

(30) Foreign Application Priority Data
Jun. 19, 2014 (JP) 2014-126370

(51) Int. Cl. G09G 3/00; G09G 3/36

(52) U.S. Cl. CPC G09G 3/007; G09G 3/36

(57) ABSTRACT

The invention reduces the occurrence of anomalies caused by reverse tilt domains of pseudo-high resolution images employing a light path shift element (the element). A liquid crystal display device includes the element changes a light path of light emitted from a liquid crystal panel, an image signal processing section generates during a first period a first image signal corresponding to a first image, generates during a second period a second image signal corresponding to a second image shifted from the first image by an amount of n pixels, and supplies the first image signal and the second image signal to the panel, and the element driver causes a light path of light emitted from the element during the second period to be shifted in the opposite direction to the direction of the shift, using the light path in the first period as a reference.

### BACKGROUND

1. Technical Field

The present invention relates to a liquid crystal display device, an electronic device, and a driving method for liquid crystal display device.

2. Related Art

In a liquid crystal panel one substrate out of a pair of substrates is provided with pixel electrodes for each pixel arrayed in a matrix pattern, and the other substrate is provided with a common electrode common to all of the pixels. Liquid crystal is held between the pixel electrodes and the common electrode. In such a configuration, when a voltage according to gradation level is applied and maintained across the pixel electrodes and the common electrode, the orientation state of the liquid crystal molecules is regulated for each of the pixels, thereby controlling the transmissivity or reflectivity thereof. Thus in such a configuration, configuration can be achieved in which, of an electric field acting on the liquid crystal molecules, only the component in the direction from the pixel electrodes to the common electrode (or the opposite direction thereto), namely the directions perpendicular to the substrate faces (referred to as the vertical direction below), contributes to display control.

There are currently demands for increasingly high resolution in liquid crystal display devices equipped with liquid crystal panels. In a projector, which is one example of a liquid crystal display device, in consideration of manufacturing costs and ease of production, there are various proposals for technology to obtain higher resolution display images without changing the resolution of the liquid crystal panels themselves (see, for example, JP-A-4-63332 and JP-A-2008-203626).

In projectors applied with such technology, generally a single frame period is divided equally into a first field period and a second field period, with a first image displayed on the liquid crystal panels in the first field period, and a second image displayed on the liquid crystal panels by shifting by 1 pixel pitch (an amount of one pixel) in a specific direction with respect to the first image during the second field period.

In the second field period, a light path shift element is employed to shift the second image in the opposite direction to the specific direction by 0.5 pixel pitch for projection. Accordingly, since in the first field period on the screen the first image and the second image displaced from each other by a 0.5 pixel pitch appear to be superimposed on each other due to the residual image effect of the human eye, a heightened resolution display image is obtained mimicking an increased number of pixels.

However, if such an image shifted by a single pixel pitch is displayed on a liquid crystal panel in succession to an original image, significant display anomalies due to poor orientation of the liquid crystals, known as reverse tilt domains, appear in regions where a dark pixel is adjacent to a bright pixel.

The reverse tilt domain is generated due to an electric field arising between mutually adjacent pixel electrodes, namely due to an electric field in a direction parallel to the substrate faces (referred to below as the lateral direction). More specifically, the reverse tilt domains are generated by disturbance of the orientation state of the liquid crystal molecules by a lateral electric field applied to the liquid crystals to be driven by the vertical direction electric field, such as in, for example, a vertical alignment (VN) method or a twisted nematic (TN) method, thus producing anomalies on the display.

More precisely, reverse tilt domains can be generated in regions where a dark pixel is adjacent to a bright pixel when an image on a liquid crystal panel is shifted by 1 pixel pitch successively with time. Reverse tilt domains are more likely to be generated as liquid crystal display devices become smaller. This is due to lateral electric fields being more likely to occur as the pixel pitch becomes smaller.

Technology is described in JP-A-2011-145501 in which display anomalies caused by reverse tilt domains are reduced. Namely, in the technology described in JP-A-2011-145501, in order to decrease the lateral electric field generated at the boundary of dark pixels and bright pixels, for example, the voltage applied to the liquid crystal molecules in the dark pixel is raised when the electrical potential of the pixel electrode of the dark pixel is positive.

However, in the technology of JP-A-2011-145501, a fall in contrast is liable to occur due to performing correction processing to change the electrical potential of the pixel electrodes, and so such technology is not appropriate for combination with technology directed toward higher resolution images.

### SUMMARY

An advantage of some aspects of the invention is that the occurrence of display anomalies due to reverse tilt domains accompanying the implementation of pseudo-high resolution images for display images is appropriately reduced, while implementing pseudo-high resolution images.

A liquid crystal display device according to a first aspect of the invention includes: a liquid crystal panel having plural pixels arranged in an array; a light path shift element capable of changing a light path of light emitted from the liquid crystal panel; an image signal processing section that, based on an input image signal, generates during a first period a first image signal corresponding to a first image, generates during a second period a second image signal corresponding to a second image shifted from the first image by an amount of n pixels (wherein n is a natural number of 2 or more), and supplies the first image signal and the second image signal to the liquid crystal panel; a light path shift element driver that drives the light path shift element, and causes a light path of light emitted from the light path shift element during the second period to be shifted in the opposite direction to the direction of the shift, using the light path of the first period as a reference.

According to this aspect, the first image is displayed on the liquid crystal panel during the first period, and the second image shifted from the first image by the amount of n pixels (wherein n is a natural number of 2 or more) is displayed on the liquid crystal panel during the second period. In the second period, light path of light emitted from the liquid crystal panel during the second period is shifted in the opposite direction to the direction of the shift, using the light path of light emitted from the liquid crystal panel in the first period as a reference. Consequently, as long as the first period and the second period are sufficiently short periods, due to the residual image effect of the human eye, the first image and the second image that are shifted slightly from each other are perceived as being superimposed on each other. A (heightened resolution) display image mimicking an increase in the number of pixels is thereby obtained.

Significant display anomalies due to reverse tilt domain occur when an image on a liquid crystal panel is shifted by an amount of 1 pixel successively with time. However, due to the second image being an image shifted with respect to the first image by the amount of n pixels (wherein n is a natural number of 2 or more), there is a large reduction in display anomalies due to reverse tilt domain.

Thus this aspect enables the implementation of pseudo-high resolution on a displayed image, whilst achieving an appropriate reduction in the occurrence of display anomalies due to reverse tilt domain accompanying pseudo-high resolution (for example such that a reduction in contrast is not induced).

In a liquid crystal display device according to the aspect of the invention, it is preferable that the light path shift element driver drive the light path shift element such that a light path of light emitted from the light path shift element in the second period is shifted by an amount of (n−0.5) pixels in the opposite direction.

According to this aspect, the second image is shifted by an amount of 0.5 pixels with respect to the first image. Thus when the liquid crystal display device is, for example, a projector, the second image is projected so as to fill in the first image, and a better display image is achieved with an image on a liquid crystal panel projected onto a screen.

In a liquid crystal display device of the aspect of the invention, it is preferable that the plural pixels be arrayed in the liquid crystal panel in a row direction and a column direction that intersect with each other, and the second image be an image shifted with respect to the first image by an amount of n pixels (wherein n is a natural number of 2 or more) in a direction intersecting with the row direction and the column direction.

According to this aspect, the second image is an image shifted in a direction intersecting with the row direction and the column direction (for example in a direction at 45° to the row direction and the column direction). The second image thereby achieves a displayed image perceived with less of an unnatural feeling than cases in which the second image is shifted in the row direction or the column direction.

An electronic device according to a second aspect of the invention is provided with the liquid crystal display device of any one of the above aspects.

According to this aspect, an electric device is provided that exhibits similar advantageous effects as the liquid crystal display of one of the above aspects.

A driving method for a liquid crystal display device according to a third aspect of the invention is a driving method for a liquid crystal display device including a liquid crystal panel having a plural pixels arranged in an array and a light path shift element capable of changing a light path of light emitted from the liquid crystal panel. The driving method for a liquid crystal display device includes: based on an input image signal, generating during a first period a first image signal corresponding to a first image and supplying the first image signal to the liquid crystal panel; generating during a second period a second image signal corresponding to a second image shifted from the first image by an amount of n pixels (wherein n is a natural number of 2 or more) and supplying the second image signal to the liquid crystal panel; and driving the light path shift element, and causing a light path of light emitted from the light path shift element during the second period to be shifted in the opposite direction to the direction of the shift, using the light path in the first period as a reference.

According to this aspect, the first image is displayed on the liquid crystal panel during the first period, and the second image shifted from the first image by the amount of n pixels (wherein n is a natural number of 2 or more) is displayed on the liquid crystal panel during the second period. In the second period, the light path of the light emitted from the liquid crystal panel is shifted in the opposite direction with respect to the direction to the shift, using the light path emitted from the liquid crystal panel during the first period as a reference. Consequently, as long as the first period and the second period are sufficiently short periods, due to the residual image effect of the human eye, the first image and the second image that are shifted slightly from each other are perceived as being superimposed on each other. A (heightened resolution) display image is thereby obtained mimicking an increase in the number of pixels.

Significant display anomalies due to reverse tilt domain occur when an image on a liquid crystal panel is shifted by an amount of 1 pixel successively with time. However, due to the second image being an image shifted with respect to the first image by the amount of n pixels (wherein n is a natural number of 2 or more), there is a large reduction in display anomalies due to reverse tilt domain.

Thus this aspect enables the implementation of pseudo-high resolution on a displayed image, whilst achieving an appropriate reduction in the occurrence of display anomalies due to reverse tilt domain accompanying pseudo-high resolution.

### BRIEF DESCRIPTION OF THE DRAWINGS

The invention will be described with reference to the accompanying drawings, wherein like numbers reference like elements.

FIG. 1 is a schematic diagram illustrating an example of a configuration of an optical system of a projector.

FIG. 2 is a diagram illustrating an example of a configuration of a light path shift element.

FIG. 3 is a schematic diagram illustrating an example of a configuration of a control system of a projector.

FIG. 4A to FIG. 4D are explanatory diagrams of an example of display images during a first field period and a second field period.

FIG. 5 is a timing chart of control of a light path shift element driver by a timing controller.

FIG. 6A is an explanatory diagram of a reverse tilt domain.

FIG. 6B is an explanatory diagram of the movement of liquid crystal molecules when a reverse tilt domain has been generated.

FIG. 7A and FIG. 7B are explanatory diagrams regarding the generation, persistence, and elimination of reverse tilt domains.

FIG. 8 is an explanatory diagram of locations where reverse tilt domains have been generated in a TN liquid crystal panel.

FIG. 9A to FIG. 9D are explanatory diagrams of an example of display images during a first field period and a second field period of a projector of a second modified example.

### DESCRIPTION OF EXEMPLARY EMBODIMENTS

Explanation follows regarding various exemplary embodiments of the invention, with reference to the appended drawings. The relative dimensions of each component in the drawings are altered from those of reality where appropriate.

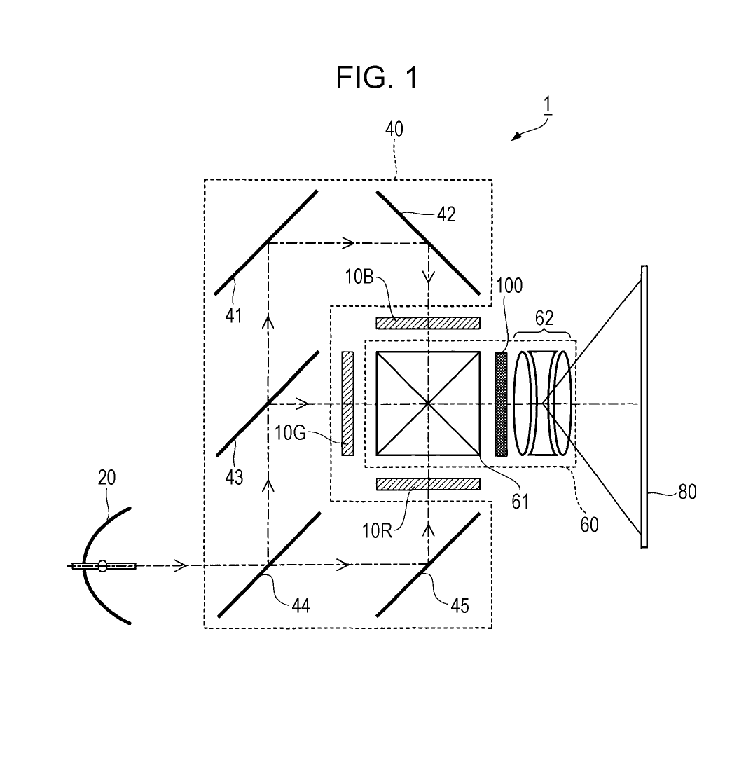

Explanation follows regarding configuration examples of an optical system of a projection type display device 1 according to a first exemplary embodiment of the invention (referred to below as a projector). FIG. 1 is a schematic diagram illustrating an example of a configuration of an optical system of the projector 1. The projector 1 includes an illumination device 20, a light splitter optical system 40, three liquid crystal panels 10R, 10G, 10B, and a projection optical system 60.

Namely, the illumination device 20 formed by a white light source, such as a halogen lamp, for example, is provided within the projector 1. The white light (visible light) emitted from the illumination device 20 is split into 3 primary colors, red (referred to below as R), green (referred to below as G), and blue (referred to below as B) by three mirrors 41, 42, 45 and dichromatic mirrors 43, 44 disposed within the projector 1, and then guided to the liquid crystal panels 10R, 10G, 10B corresponding to the respective primary colors. The light splitter optical system 40 includes the mirrors 41, 42, 45 and the dichromatic mirrors 43, 44, and splits the white light emitted from the illumination device 20 into the 3 primary colors R, G, B.

More specifically, the dichromatic mirror 44 transmits light of the R wavelength band in the white light, and reflects light of the G, B wavelength bands. The dichromatic mirror 43 transmits light of the B wavelength band from out of the G, B wavelength bands reflected by the dichromatic mirror 44, and reflects the G wavelength band.

The liquid crystal panels 10R, 10G, 10B are each employed as spatial light modulators. The liquid crystal panels 10R, 10G, 10B each include, for example, 1080 rows of scan lines and 1920 columns of data lines, include pixels arrayed in a matrix shape of 1080 rows arranged along the height direction and 1920 columns arranged along the width direction, and controls the polarization state of emitted (transmitted) light from the incident light in each of the pixels according to their gradation. The numbers of the scan lines, data lines, and pixels of the liquid crystal panels 10R, 10G, 10B referred to above are merely examples thereof, and there is no limitation to the above examples.

In the liquid crystal panels 10R, 10G, 10B, pixel electrodes are provided that correspond to the intersections between the scan lines and the data lines, and that each exhibit a substantially square shaped profile. A common facing electrode is provided so as to face the pixel electrodes and to span across each of the pixels. A VA liquid crystal, for example, is provided between the pixel electrodes and the facing electrodes.

In such a configuration, when a given scan line is selected, a voltage of the data line corresponding to the pixel electrodes positioned on the selected scan line is applied to these pixel electrodes, and configuration is made such that the applied voltage is maintained by capacitance even if selection is released.

The light modulated respectively by the liquid crystal panels 10R, 10G, 10B is incident to a dichromatic prism 61 from 3 directions. In the dichromatic prism 61, the R light and the B light is reflected at 90°, and the G light passes straight through, so as to combine in an image of each of the primary colors R, G and B.

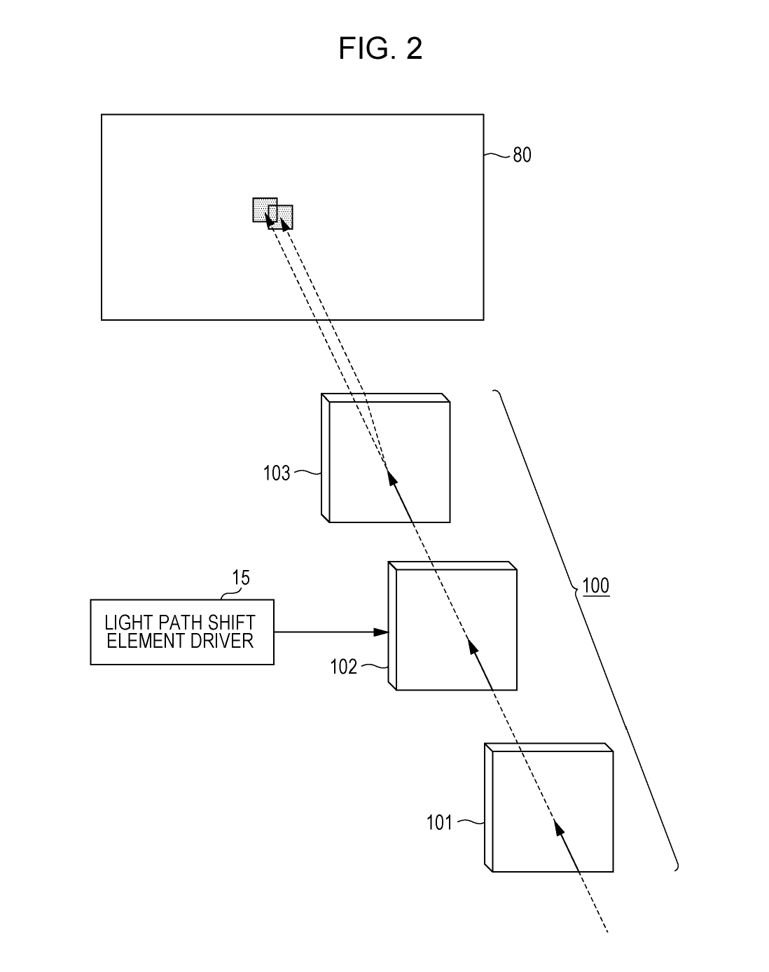

A light path shift element 100 and a projection lens system 62 are disposed in this sequence on the emission side of the dichromatic prism 61. The light path shift element 100 is an element that shifts emitted light in a specific direction with respect to incident light. A more specific example of a configuration of the light path shift element 100 is described later with reference to FIG. 2.

The projection lens system 62 spreads and projects the light emitted from the light path shift element 100 (the combined image) onto a projection screen 80. Light of the primary colors R, G, B is incident to the respective corresponding liquid crystal panels 10R, 10G, 10B due to the dichromatic mirrors 43, 44, and so color filters are not required.

The images transmitted by the liquid crystal panels 10R, 10B are projected onto the projection screen 80 after being reflected by the dichromatic prism 61, but the image transmitted by the liquid crystal panel 10G passes straight through the dichromatic prism 61 and is projected. This means that the images formed by the liquid crystal panels 10R, 10B, and the image formed by the liquid crystal panel 10G, have a left-right inverted relationship to each other.

As described above, the projection optical system 60 includes the dichromatic prism 61, the light path shift element 100, and the projection lens system 62.

FIG. 2 is a diagram illustrating an example of a configuration of the light path shift element 100. The light path shift element 100 is driven according to an output signal of a light path shift element driver 15 (a control signal CTL described below), and shifts the light path of incident light. When the light path of light emitted from the dichromatic prism 61 is shifted by the light path shift element 100, the image is displayed shifted on the projection screen 80, as illustrated in FIG. 2. In the example illustrated in FIG. 2, a first optical element 101 is, for example, a ½ wavelength plate, a second optical element 102 is, for example, a polarization angle rotation element, and a third optical element 103 is, for example, a double refraction element.

The configuration of the light path shift element 100 is not limited to the example illustrated in FIG. 2, and any configuration may be adopted as long as the light path of the light emitted from the dichromatic prism 61 is shifted.

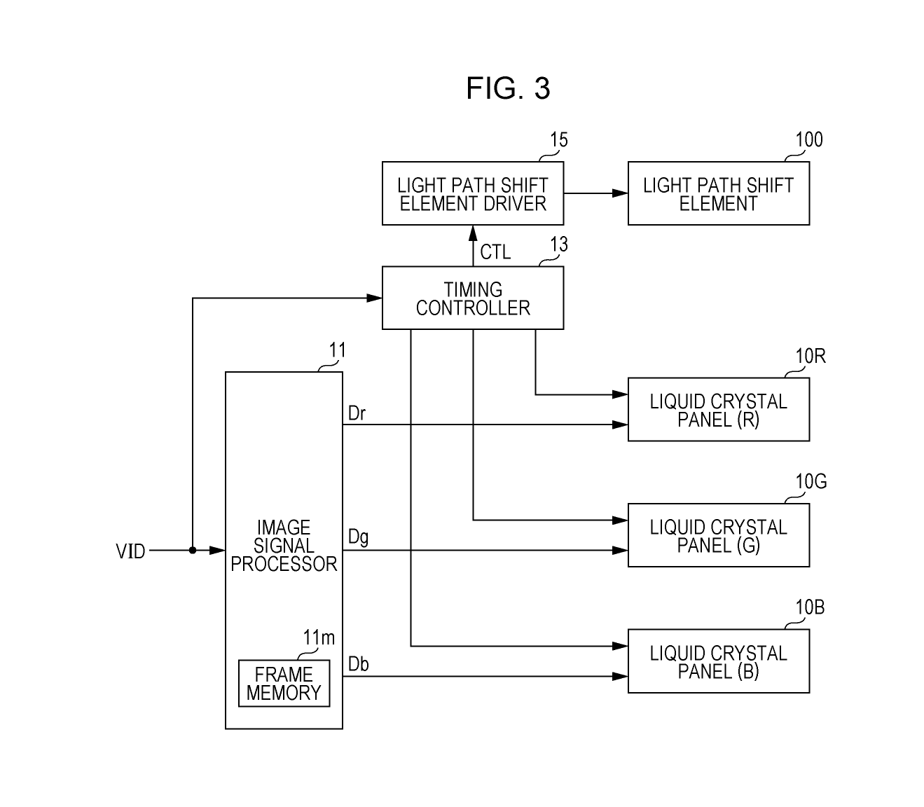

Explanation follows regarding a configuration of a control system of the projector 1. FIG. 3 is a schematic diagram illustrating an example of the configuration of a control system the projector 1. The projector 1 illustrated in FIG. 3 includes an image signal processor 11 equipped with a frame memory 11m, a timing controller 13, and the light path shift element driver 15.

The image signal processor 11 stores frames of each color (R, G, B) of a video signal VID input to the projector 1 in the frame memory 11m. Periods resulting from equally dividing the period of a single frame are referred to as a first field period and a second field period. When driving the liquid crystal panels 10R, 10G, 10B, the image signal processor 11 reads data signals (Dr, Dg, Db) of respective frames from the frame memory 11m, and supplies the data signals to the liquid crystal panels 10R, 10G, 10B, such that images shifted by a specific pixel pitch are displayed on the liquid crystal panels 10R, 10G, 10B during the first field period and the second field period.

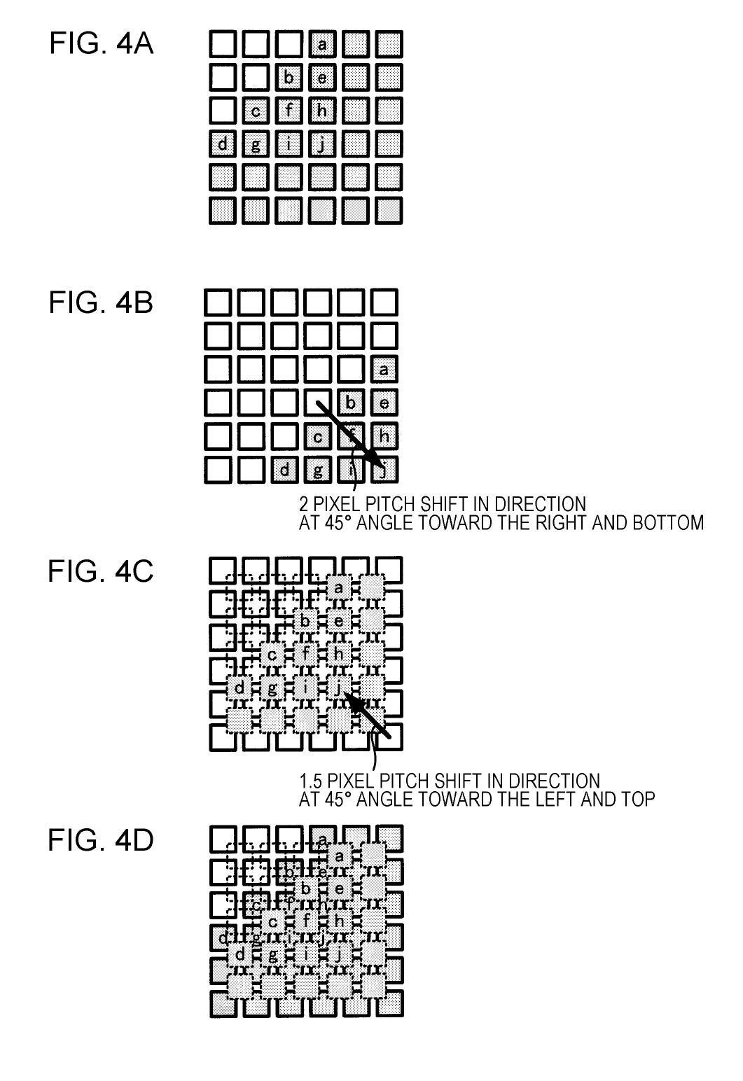

In the following, an image displayed on the liquid crystal panels 10R, 10G, 10B during the first field period is referred to as an image P, and an image displayed on the liquid crystal panels 10R, 10G, 10B during the second field period is referred to as an image Q. FIG. 4A to FIG. 4D illustrate examples of display of the image P and the image Q.

The image Q illustrated in FIG. 4B is an image from a data signal (Dr, Dg, Db) of the same frame as the image P illustrated in FIG. 4A, and is an image shifted by 2 pixel pitches with respect to the image P in a specific direction. The specific direction here is, for example, a direction intersecting with the mutually intersecting row direction and column direction. In the example illustrated in FIGS. 4A to 4D, the specific direction is a direction toward the right and bottom, at substantially 45° to the row direction and the column direction.

Namely, in the present exemplary embodiment, the image signal processor 11 reads from the frame memory 11m the data signals (Dr, Dg, Db) for displaying, on the liquid crystal panels 10R, 10G, 10B, the image P and the image Q shifted from each other by 2 pixel pitches in the direction toward the right and bottom, at substantially 45° to the row direction and the column direction, and supplies the data signals to the liquid crystal panels 10R, 10G, 10B.

In other words, in the first period (first field period) the image signal processor 11 generates a first image signal (data signal) corresponding to a first image (image P), in the second period (second field period) the image signal processor 11 generates a second image signal (data signal) corresponding to a second image (image Q) shifted by an amount of n pixels (where n is a natural number of 2 or more) from the first image (image P), and the image signal processor 11 supplies the first image signal (data signal) and the second image signal (data signal) to the liquid crystal panels 10R, 10G, 10B.

The timing controller 13 generates a clock signal for supply of the data signals to each of the pixel electrodes of the liquid crystal panels 10R, 10G, 10B, and supplies the clock signal to the data line drive circuits of the liquid crystal panels 10R, 10G, 10B (not illustrated in the drawings).

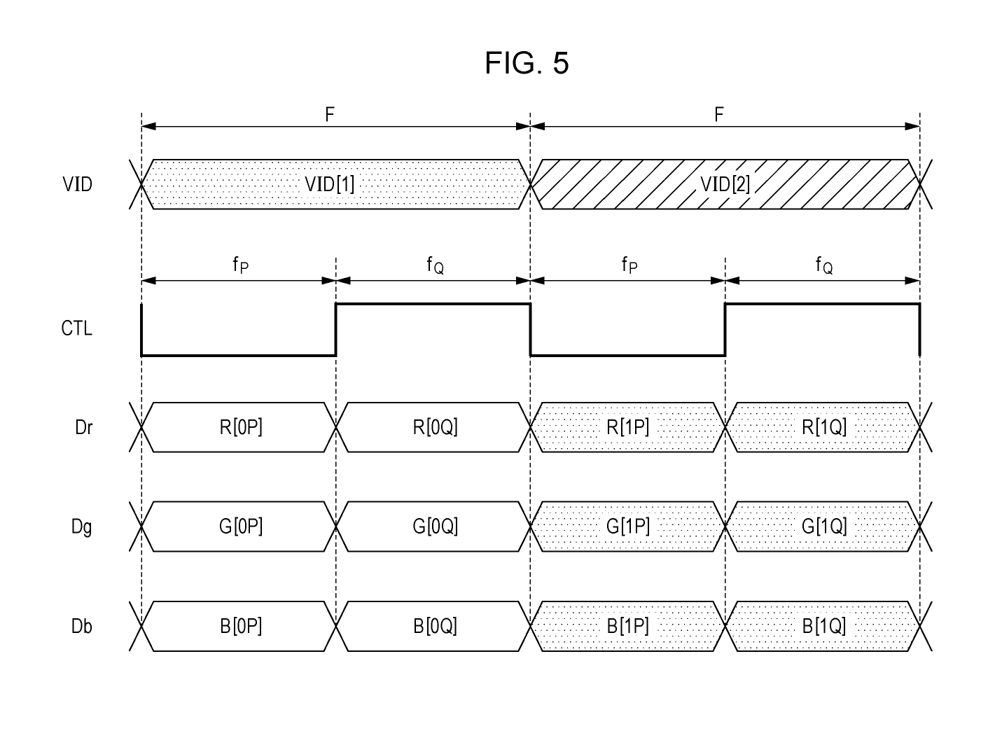

The timing controller 13 also controls the timing of driving the light path shift element 100 by controlling the light path shift element driver 15 based on the input video signal VID. FIG. 5 illustrates a timing chart related to the control of the light path shift element driver 15 by the timing controller 13.

In FIG. 5, F denotes a single frame period, fₚ denotes the first field period, f_{q} denotes the second field period, and VID[k] denotes the image signal of the k^{th} frame. In FIG. 5, CTL denotes the control signal used by the timing controller 13 to operate the light path shift element driver 15.

In FIG. 5, R[kP] denotes the R data signal for the image P of the k^{th} frame, R[kQ] denotes the R data signal for the image Q of the k^{th} frame, G[kP] denotes the G data signal for the image P of the k^{th} frame, G[kQ] denotes the G data signal for the image Q of the k^{th} frame, B[kP] denotes the B data signal for the image P of the kth frame, and B[kQ] denotes the B data signal for the image Q of the kth frame.

The video signal VID containing the respective R, G, B data signals is time divided and input to the image signal processor 11 and the timing controller 13. Each frame for each color of the video signal VID input to the image signal processor 11 is stored in the frame memory 11m. In the example illustrated in FIG. 5, the video signal VID[1] of the first frame stored in the frame memory 11m is read as data signals R[1P], G[1P], B[1P] for the image P in the first field period f_{P} and supplied to the liquid crystal panels 10R, 10G, 10B.

Then the video signal VID[1] of the first frame is read as data signals R[1Q], G[1Q], B[1Q] for the image Q in the second field period f_{Q} and supplied to the liquid crystal panels 10R, 10G, 10B, and the level of the control signal CTL is set by the timing controller 13 to high level to operate the light path shift element driver 15.

Thus in the second field period f_{Q}, the light path shift element 100 is driven by the light path shift element driver 15, and the projected image of (the light path of) image Q on the projection screen 80 is, as illustrated in FIG. 4C, shifted in the opposite direction to the shift direction by the image signal processor 11 (the shift direction on the liquid crystal panels 10R, 10G, 10B) so as to be shifted by 1.5 pixel pitches.

The difference between the shift amount of the image Q with respect to the image P on the liquid crystal panels 10R, 10G, 10B, and the shift amount of the shift by the light path shift element 100 is preferably 0.5 pixel pitches (or a value close to 0.5 pixels). Thus due to the residual image effect of the human eye, each of the pixels configuring the image Q in the second field period f_{Q} are perceived as filling in the gaps between each of the pixels configuring the image P in the first field period f_{P} on the projection screen 80, as illustrated in FIG. 4D. Namely, a viewer perceives pseudo high resolution image on the projection screen 80.

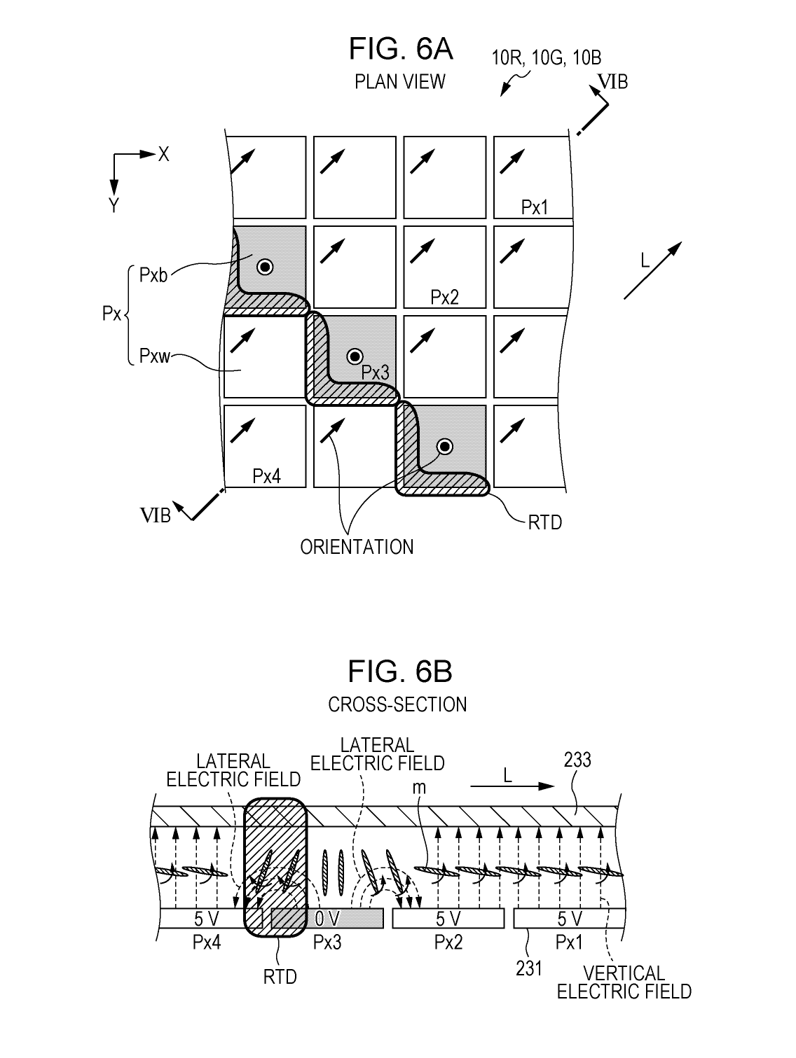

In the pseudo high resolution processing of images in technology hitherto, an image shifted in a specific direction by one pixel pitch with respect to a displayed image in the first field period is employed as the display image during the second field period. Such processing gives rise to significant display anomalies due to the reverse tilt domains. Explanation follows regarding reverse tilt domains, with reference to FIG. 6A, and the movement of liquid crystal molecules m when reverse tilt domains are generated, with reference to FIG. 6B.

FIG. 6A is a diagram illustrating gradation for display of 1 frame of 16 pixels Px arranged in 4 rows and 4 columns, and is a diagram illustrating a reverse tilt domain RTD that is generated in the 16 pixels Px. The pixels Px displayed in white in FIG. 6A are bright pixels Pxw with a white display voltage applied to a liquid crystal layer, and the pixels Px displayed in black are dark pixels Pxb with a black display voltage applied to the liquid crystal layer. The liquid crystals of the bright pixels Pxw are oriented toward a bright view direction L side, and the liquid crystal molecules of the dark pixels Pxb are oriented in a direction orthogonal to the face of the page.

FIG. 6B is a schematic diagram depicting a cross-section taken along on a straight diagonal line VIB-VIB passing through 4 pixels Px1 to Px4 of the 16 pixels Px illustrated in FIG. 6A. The pixels Px1, Px2, Px4 are bright pixels Pxw applied with the white display voltage, and the pixel Px3 is a dark pixel Pxb applied with the black display voltage. In FIG. 6B, the electrode appended with 231 is a pixel electrode, and the electrode appended with 233 is a facing electrode 233.

As illustrated in FIG. 6B, there is a lateral electric field present between the pixel electrode 231 of the pixel Px3 and the pixel electrode 231 of the pixel Px4. Due to the influence of this lateral electric field, the liquid crystal molecules m present between the pixel Px3 and the pixel Px4 adopt a perturbed state with an orientation tilted in the opposite direction to the bright view direction L, forming the reverse tilt domain RTD. When liquid crystal molecules m have poor orientation, due to it taking a fixed period of time for these liquid crystal molecules m to return to a state tilted as originally to the bright view direction L side, the reverse tilt domain RTD persists for the fixed period of time.

The reverse tilt domain RTD here is generated in the vicinity of the boundary between 2 pixels Px where a bright pixel Pxw is adjacent to a dark pixel Pxb on the opposite side to the bright view direction L as viewed from the dark pixel Pxb.

As illustrated in FIG. 6B, a lateral electric field is also present between the pixel electrode 231 of the pixel Px3 and the pixel electrode 231 of the pixel Px2. This lateral electric field is a lateral electric field that tilts liquid crystal molecules m toward the bright view direction L side. Due to the liquid crystal molecules m originally being controlled by a vertical electric field so as to tilt toward the bright view direction L side, when the liquid crystal molecules m are tilted toward the bright view direction L side due to the influence of the lateral electric field, orientation can be rapidly returned to the original tilt (that when the lateral electric field is not present) by eliminating the lateral electric field. Reverse tilt domain RTD accordingly is not liable to be formed in such cases.

The reverse tilt domain RTD is accordingly generated in the vicinity of the boundary between the pixel Px3 and the pixel Px4, namely, at the boundary between 2 pixels Px where a bright pixel Pxw is adjacent to a dark pixel Pxb on the opposite side to the bright view direction L as viewed from the dark pixel Pxb.

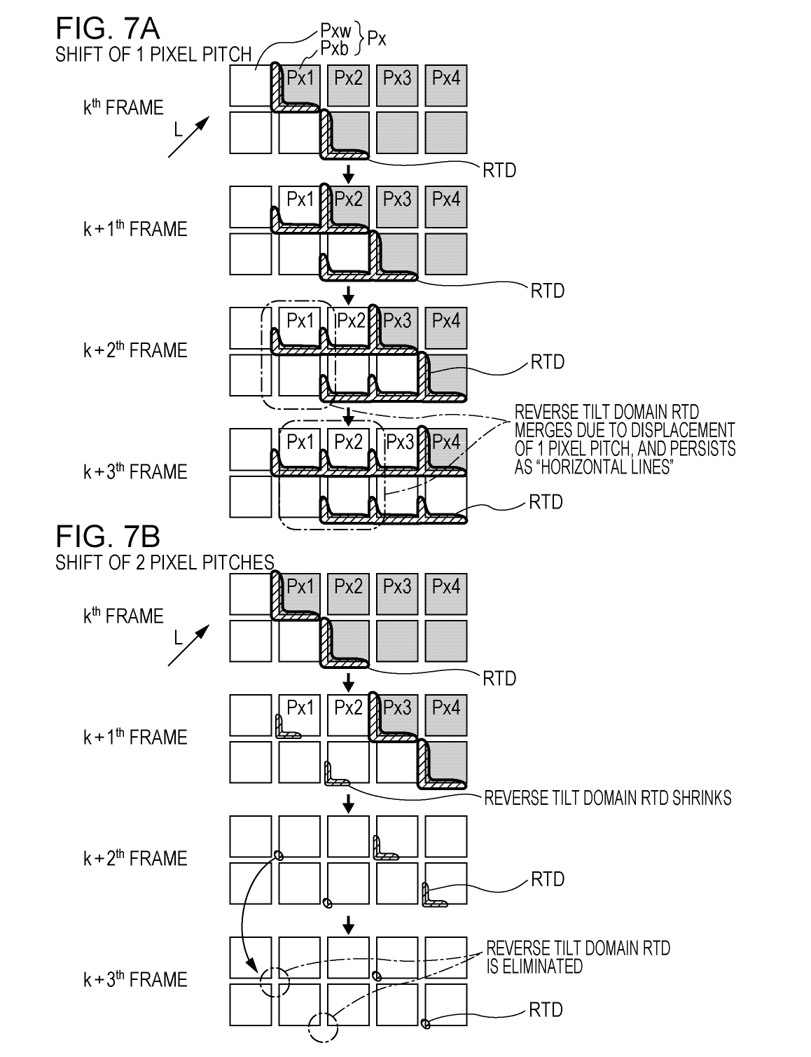

When the reverse tilt domain RTD generated in this manner persists for a long period of time, this is perceived by the user as an anomaly on the display. The period of time that the reverse tilt domain RTD persists depends on the gradation after the reverse tilt domain RTD was generated, for the pixels Px in the vicinity of the location where the reverse tilt domain RTD was generated. More specific explanation follows, with reference to FIG. 7A. FIG. 7A illustrates a reverse tilt domain RTD generated when an image displayed on a liquid crystal panel is shifted (scrolled) by 1 pixel pitch to the right. The processing to shift the image displayed on the liquid crystal panel by 1 pixel pitch is, for example, performed by processing that gives pseudo-high resolution in an existing liquid crystal display device.

In FIG. 7A, the dark pixels Pxb are shown in black, and the bright pixels Pxw are shown in white, and the reverse tilt domain is shown with diagonal shading.

As illustrated in FIG. 7A, when the dark pixels Pxb in a frame are shifted by 1 pixel to the right, and the bright pixels Pxw adjacent to those dark pixels Pxb in the frame are also shifted by 1 pixel to the right, the reverse tilt domain RTD spreads out in the shift direction, and persists over a long period.

More specifically, in the k^{th} frame, the reverse tilt domain RTD is generated in the vicinity of the left edge and the bottom edge of the pixel Px1, and in the subsequent k+1^{th} frame, the reverse tilt domain RTD is generated in the vicinity of the left edge and the bottom edge of the pixel Px2. A single region formed as the reverse tilt domain generated in the k^{th} frame then merges with the reverse tilt domain generated in the k+1^{th} frame. Similarly, in the k+2^{th} frame and the k+3^{th} frame, a new reverse tilt domain RTD is generated, and these also merge with the reverse tilt domains RTD generated in the k^{th} frame and the k+1^{th} frame. As a result, the reverse tilt domain spreads out in the lateral direction, and a lateral row of black lines appears in pixels Px that should be displaying white, forming “horizontal lines”.

The liquid crystal molecules m present in the region where the reverse tilt domain is formed support each other due to holding perturbed orientation states. The force with which the orientation perturbed liquid crystal molecules m support each other gets stronger as plural reverse tilt domains RTD merge together and the region spreads out. The horizontal lines formed by the merging of the plural reverse tilt domains RTD therefore persist for a long period of time. Perturbation of the orientation of the liquid crystal molecules m is liable to occur in the pixels Px interposed between these horizontal lines, and anomalies in display are particularly likely to occur.

FIG. 7B illustrates a reverse tilt domain RTD that occurs in a case in which an image displayed on a liquid crystal panel is shifted (scrolled) by increments of 2 pixel pitches to the right. The processing to shift the image displayed on the liquid crystal panel by 2 pixel pitches may, for example, be performed by processing to give pseudo-high resolution in a projector according to the present exemplary embodiment. Similarly to in FIG. 7A, the dark pixels Pxb are shown in black, the bright pixels Pxw are shown in white, and the reverse tilt domain is shown with diagonal shading.

As illustrated in FIG. 7B, when the black pixels Pxb are shifted by increments of 2 pixels to the right in a single frame, and the bright pixels Pxw adjacent to the dark pixels Pxb are also shifted by increments of 2 pixels to the right in the single frame, the reverse tilt domain is eliminated in a comparatively short period of time.

More specifically, the reverse tilt domain is generated in the k^{th} frame at the vicinity of the bottom edge and left edge of the pixel Px1 that is a dark pixel Pxb. Then in the k+1^{th} frame, a reverse tilt domain RTD is generated in the vicinity of the bottom edge and left edge of the pixel Px3 that is a dark pixel Pxb, however the pixel Px2 becomes a bright pixel Pxw, and so the lateral electric field present at the vicinity of the left edge and the bottom edge of the pixel Px1 is eliminated. When the lateral electric field has been eliminated, the liquid crystal molecules m within the region of the reverse tilt domain RTD are able to tilt to the bright view direction L side. The liquid crystal molecules m present in the periphery of the region of the reverse tilt domain RTD are driven by the vertical electric field and tilted toward the bright view direction L side, and so the liquid crystal molecules m in the region of the reverse tilt domain RTD are affected by this occurring, and are gradually tilted toward the bright view direction L side. As a result, the region of the reverse tilt domain RTD gradually shrinks.

In the k+2^{th} frame and the k+3^{th} frame, the 10 pixels Px thus all become bright pixels Pxw, a state continues in which there is no lateral electric field present in the 10 pixels Px, and the reverse tilt domain RTD present at the pixel Px1 gradually reduces, and is soon eliminated. In cases in which the reverse tilt domain RTD is eliminated over a comparatively short period of time in this manner, the likelihood of a user perceiving display anomalies caused by the reverse tilt domain RTD becomes extremely low.

The present exemplary embodiment utilizes the principles illustrated in FIG. 7B, and realizes pseudo-high resolution while reducing display anomalies caused by reverse tilt domains RTD while realizing the pseudo-high resolution. Namely, in the present exemplary embodiment, the image Q for display in the second field period is shifted by 2 pixels (or 2 pixels or more) with respect to the image P for display in the first field period, thereby preventing reverse tilt domains RTD from merging together, as illustrated in the example of FIG. 7B, and greatly reducing display anomalies caused by reverse tilt domains RTD. More specifically, in the second field period the image Q is displayed on the liquid crystal panels 10R, 10G, 10B such that the reverse tilt domains RTD do not merge with each other. This thereby enables the suppression of horizontal lines generated by merging with the reverse tilt domains RTD generated in the plural dark pixels Pxb, and reducing display anomalies.

When the amount of shifting between the image P and the image Q on the liquid crystal panels 10R, 10G, 10B is n-pixel pitches, wherein n is a natural number of two or more, the light path shift element driver 15 preferably drives the light path shift element 100 such that the light path of light emitted from the light path shift element 100 during the second field period is shifted in the opposite direction by an amount of (n−0.5) pixels.

As explained above, the present exemplary embodiment provides a liquid crystal display device, an electronic device, and a driving method for a liquid crystal display device, that are capable of realizing pseudo-high resolution of a display image, whilst appropriately reducing the generation of display anomalies due to reverse tilt domains accompanying the implementation of pseudo-high resolution.

An exemplary embodiment of the invention has been explained above, however the following modifications may be applied to such an exemplary embodiment.

### First Modified Example

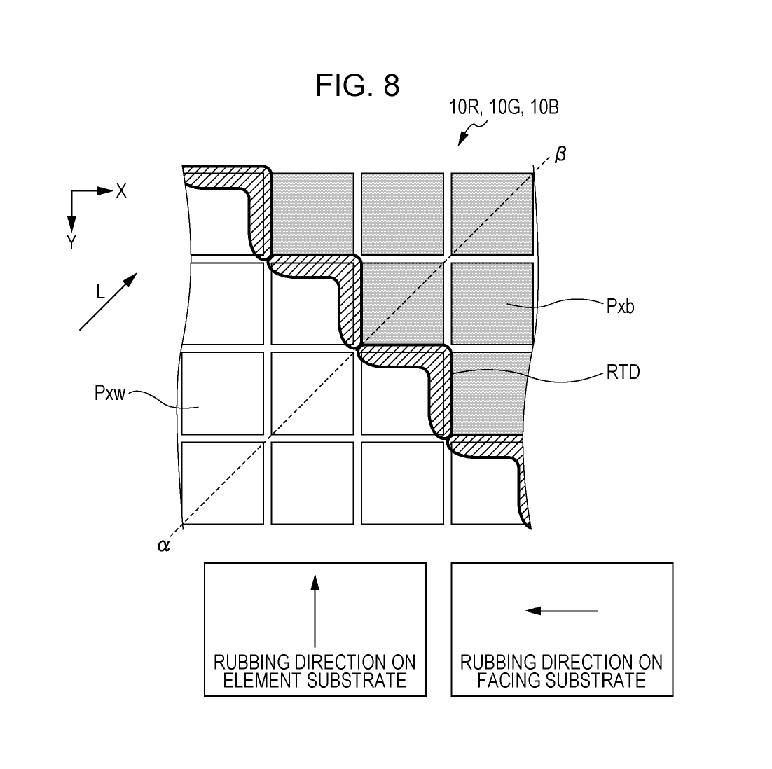

In the above exemplary embodiment a VA liquid crystal panel was employed in the liquid crystal panels 10R, 10G, 10B, however obviously TN liquid crystals may be employed. In cases in which TN liquid crystal panels are employed, the bright view direction of the liquid crystals, and the location where reverse tilt domains are generated are different from the VA liquid crystals of the exemplary embodiment described above. For example, consider a case in which normally white mode liquid crystal molecules are employed. In such cases, as illustrated in FIG. 8, when rubbing treatment is performed on the facing substrate along the scan line direction from the right hand side toward the left hand side in the drawing, and rubbing treatment is performed on the element substrate along the data line direction from the bottom side toward the top side in the drawing, the bright view direction L of the liquid crystals is a direction from α at the bottom left to β at the top right of the drawing, and a region where a reverse tilt domain is generated is a region in the bright pixels Pxw on the bright view direction side.

### Second Modified Example

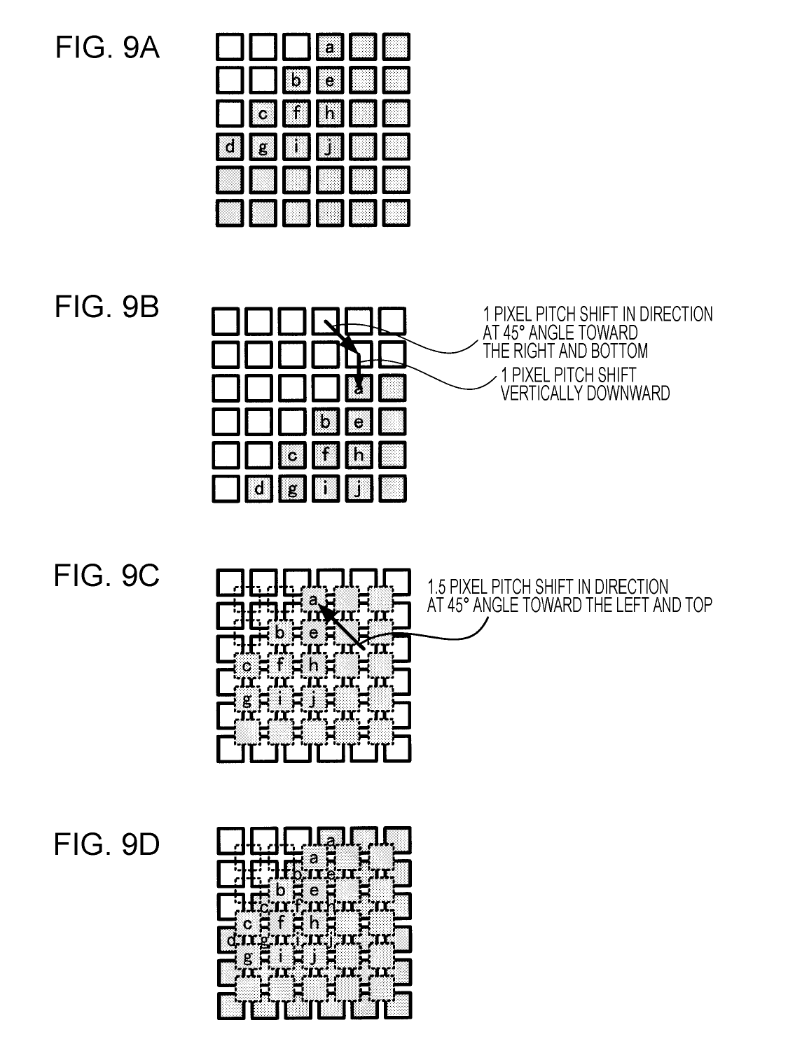

FIG. 9A to FIG. 9D are explanatory diagrams of an example of a display image in a first field period f_{P} and a second field period f_{Q} in a projector according to a second modified example. In the second modified example, by generating the image Q as illustrated in FIG. 9A to FIG. 9D, an edge in a diagonal direction in an image P on the projection screen 80 is perceived as being filled in more smoothly.

In the exemplary embodiment described above, and as illustrated in FIGS. 4A and 4B, an image from the data signal (Dr, Dg, Db) of the same frame as the image P, shifted with respect to image P by 2 pixel pitches in a direction toward the right and bottom, at substantially 45° to the row direction and the column direction, serves as the image Q.

However in the second modified example, an image from the data signal (Dr, Dg, Db) of the same frame as the image P (see FIG. 9A), shifted by 1 pixel pitch in a direction toward the right and bottom, at substantially 45° to the row direction and the column direction, and shifted by 1 pixel pitch in the vertically downward direction with respect to the row direction, with respect to the image P, serves as an image Q (see FIG. 9B).

In the second field period f_{Q}, the light path shift element 100 is driven by the light path shift element driver 15 similarly to in the above exemplary embodiment, and as illustrated in FIG. 9C, the projected image on the projection screen 80 of (the light path of) the image Q is shifted by 1.5 pixel pitches in a direction toward the left and top, at substantially 45° to the row direction and the column direction.

Thus due to the residual image effect of the human eye, each of the pixels configuring the image Q in the second field period f_{Q} are perceived as filling in the gaps between each of the pixels configuring the image P of the first field period f_{P}, as illustrated in FIG. 9D. Namely, on the projection screen 80 the edge in the diagonal direction on the image P is perceived as being more smoothly filled in than in the exemplary embodiment described above. Namely, the image is perceived on the projection screen 80 by a viewer to be pseudo-high resolution.

### Application Examples

An eyepiece is provided on the back of digital cameras for the photographer to look into, and an electronic view finder (EVF) is provided within the camera body to correspond to the eyepiece. Such an EVF is provided with a liquid crystal panel serving as an EVF image display section, and a drive control device to drive the liquid crystal panel.

Providing the light path shift element 100 and the light path shift element driver 15 of the exemplary embodiment described above to the liquid crystal panel employed as the EVF image display section, and applying the processing of the image signal processor 11 and the timing controller 13, enables a digital camera to be provided that implements pseudo-high resolution on a display image, while appropriately reducing the generation of display anomalies due to reverse tilt domains accompanying the implementation of pseudo-high resolution.

This application claims priority to Japan Patent Application No. 2014-126370 filed Jun. 19, 2014, the entire disclosures of which are hereby incorporated by reference in their entireties.

What is claimed is:

1. A liquid crystal display device comprising:
a liquid crystal panel having a plurality of pixels arranged in an array;
a light path shift element capable of changing a light path of light emitted from the liquid crystal panel;
an image signal processing section that, based on an input image signal, generates during a first period a first image signal corresponding to a first image, generates during a second period a second image signal corresponding to a second image shifted from the first image by an amount of n pixels (wherein n is a natural number of 2 or more), and supplies the first image signal and the second image signal to the liquid crystal panel; and
a light path shift element driver that drives the light path shift element, and causes a light path of light emitted from the light path shift element during the second period to be shifted in the opposite direction to the direction of the shift, using the light path in the first period as a reference.

2. The liquid crystal display device of claim 1, wherein the light path shift element driver drives the light path shift element such that a light path of light emitted from the light path shift element in the second period is shifted by an amount of (n−0.5) pixels in the opposite direction.

3. The liquid crystal display device of claim 1, wherein:
the plurality of pixels are arrayed in the liquid crystal panel in a row direction and a column direction that intersect with each other; and
the second image is an image shifted with respect to the first image by an amount of n pixels (wherein n is a natural number of 2 or more) in a direction intersecting with the row direction and the column direction.

4. An electronic device including the liquid crystal display device of claim 1.

5. An electronic device including the liquid crystal display device of claim 2.

6. An electronic device including the liquid crystal display device of claim 3.

7. A driving method for a liquid crystal display device including a liquid crystal panel having a plurality of pixels arranged in an array and a light path shift element capable of changing a light path of light emitted from the liquid crystal panel, the driving method for a liquid crystal display device comprising:
based on an input image signal, generating during a first period a first image signal corresponding to a first image and supplying the first image signal to the liquid crystal panel;
generating during a second period a second image signal corresponding to a second image shifted from the first image by an amount of n pixels (wherein n is a natural number of 2 or more) and supplying the second image signal to the liquid crystal panel; and
driving the light path shift element, and causing a light path of light emitted from the light path shift element during the second period to be shifted in the opposite direction to the direction of the shift, using the light path in the first period as a reference.
